(19) United States
(12) Patent Application Publication
(10) Pub. No.: US 2022/0358901 A1
(43) Pub. Date: Nov. 10, 2022

(54) FLAME THROWER PIPE ORGAN

(71) Applicant: Jonathan Elkins, Saratoga Springs, UT (US)

(72) Inventor: Jonathan Elkins, Saratoga Springs, UT (US)

(21) Appl. No.: 17/737,963

(22) Filed: May 5, 2022

Related U.S. Application Data
(60) Provisional application No. 63/184,617, filed on May 5, 2021.

(51) Int. Cl. G10H 1/00; F23Q 3/00; F23D 14/20; F23D 14/26; G10H 1/34; G10F 5/02; G10F 1/00

(52) U.S. Cl. CPC G10H 1/0008; F23Q 3/008; F23D 14/20; F23D 14/26; G10H 1/344; G10F 5/02; G10F 1/00; A63J 5/02

(57) ABSTRACT

A micro flame effects unit (MFEU) includes a solenoid valve, an ignition coil, and a pair of electrodes. The ignition coil is to receive a voltage to create a spark between end portions of the electrodes. The solenoid valve is to receive a voltage to release gas, the spark and the gas to create a flame effect. An example flame thrower pipe organ (FTPO) includes a set of cylindrical members with a micro flame effects unit (MFEU) located within each cylindrical member. The FTPO further includes a set of keys that provide a sound when a key of the set of keys is played. A control device causes an MFEU to release a flame effect concurrent with the sound of a corresponding key being played. The FTPO may be automated with a self-playing system.

### BACKGROUND

A pipe organ is a musical instrument that produces sound by driving pressurized air, or wind, through organ pipes. The pipe organ has a continuous supply of wind that allows it to sustain notes through the organ pipes for as long as the corresponding keys of the keyboard are pressed.

### BRIEF DESCRIPTION OF DRAWINGS

The accompanying drawings illustrate various implementations of the principles described herein and are a part of the specification. The illustrated implementations are merely examples and do not limit the scope of the claims.

FIG. 1 shows a perspective view of an example of a flame thrower pipe organ (FTPO) being played, according to principles described herein.

FIG. 2 shows a perspective view of an example of an FTPO being played, according to principles described herein.

FIG. 3 shows a front view of an example micro flame effects unit (MFEU), according to principles described herein.

FIG. 4 shows a back view of an example MFEU, according to principles described herein.

FIG. 5a shows a front view of an example MFEU, according to principles described herein.

FIG. 5b shows a bottom view of an example MFEU, according to principles described herein.

FIG. 5c shows a cutout view of an example MFEU, according to principles described herein.

FIG. 6 shows a perspective view of an example MFEU, according to principles described herein.

FIG. 7 shows a top view of an example MFEU, according to principles described herein.

FIG. 8 shows a front view of an example electrode and a gas pipe, according to principles described herein.

FIG. 9 shows a front view of an example electrode and a gas pipe, according to principles described herein.

FIG. 10 shows a front view of an example gas pipe, according to principles described herein.

FIG. 11 shows a front view of an example gas pipe, according to principles described herein.

FIG. 12a shows a perspective view of example connection components to be attached to the block, according to principles described herein.

FIG. 12b shows a perspective view of an example connection component to be attached to the block, according to principles described herein.

FIG. 12c shows a perspective view of an example connection component to be attached to the block, according to principles described herein.

FIG. 12d shows a perspective view of an example connection component to be attached to the block, according to principles described herein.

FIG. 12e shows a perspective view of an example connection component to be attached to the block, according to principles described herein.

FIG. 13 shows a perspective view of an example MFEU with connection components attached, according to principles described herein.

FIG. 14 shows a perspective view of an example MFEU with connection components attached, according to principles described herein.

FIG. 15 shows a perspective view of an example MFEU with connection components, according to principles described herein.

FIG. 16 shows a perspective view of an example MFEU with connection components to be attached, according to principles described herein.

FIG. 17a shows an example gas regulator, according to principles described herein.

FIG. 17b shows an example pilot light ignition method, according to principles described herein.

FIG. 18 shows a diagram for a manual FPTO, according to principles described herein.

FIG. 19 shows a side view of an example piano key to be used in a manual play FPTO, according to principles described herein.

FIG. 20 shows a diagram for an automatic FPTO, according to principles described herein.

### DETAILED DESCRIPTION

The following describes a keyboard and pipe arrangement that provide the appearance of a flame thrower pipe organ (FTPO) in which flame effects shoot out of pipes as keys of a keyboard are played. The keyboard and pipe arrangement may be used to heighten the experience of an organ playing music. For example, the scary ambience of a house that is decorated to look haunted may benefit from an organ that plays music with flame effects coming out of the pipes. In another example, the mood of an evening concert may benefit from music that displays flames in sync with the beat of the music. Other applications are anticipated.

A Flame Effects Device (FED) is a general category of devices that are used to create flame effects for a variety of applications (i.e. light shows, special effects for amusement parks and video productions, concerts, sporting events, holiday attractions etc.) FEDs may use a gaseous fuel, a solid fuel, a liquid fuel, or a combination thereof. The ignition of the fuel may be a pre-lit flame, electric arcs, sparks, hot wire, etc. FEDs may be manually controlled or automatically controlled, and controlled locally or remotely. There are a wide variety of FED designs, configurations, and methods of operation, and all have the purpose of creating flame effects.

A micro flame effects unit (MFEU) is a type of FED that is used to create the flame effects in the FTPO. A MFEU includes a solenoid valve, an ignition coil, and a pair of electrodes that extend outward from the ignition coil. End portions of the electrodes are curved or angled toward each other. A gas pipe is located adjacent to the pair of electrodes. The ignition coil is to receive a voltage to create a spark between end portions of the electrodes. The solenoid valve is to receive a voltage to release gas from the gas pipe, the spark and the gas to create a flame effect.

An example flame thrower pipe organ (FTPO) includes a set of cylindrical members with a micro flame effects unit (MFEU) located within each cylindrical member. The FTPO further includes a set of keys that provide a sound when a key of the set of keys is played. A control device is attached to the set of keys and to the MFEUs. The control device causes an MFEU to release a flame effect concurrent with the sound of a corresponding key being played.

An automatic flame thrower pipe organ (FTPO) includes a set of cylindrical members with a micro flame effects unit (MFEU) located within each cylindrical member. A control device is connected to the MFEUs to control the release of each flame effect. A keyboard is located adjacent to the set of cylindrical members. The keyboard includes a set of keys with solenoids underneath them. A self-playing system controls the solenoids to play the keys, each key making a sound. The control device is connected to the self-playing system such that the MFEUs release a flame effect concurrent with a corresponding key being played by the self-playing system.

Although the term “flame” and “flames” are referenced throughout the specification, it is to be understood that the term further encompasses the terms “flame effect” and “flame effects.” A “flame effect” is defined as “the combustion of solids, liquids, or gases to produce thermal, physical, visual, or audible phenomena before an audience.” This includes all flames that are automated, switched, pressurized or that have any other action than simply being lit on fire. This further includes a flame that uses propane or other liquid or gaseous fuels.

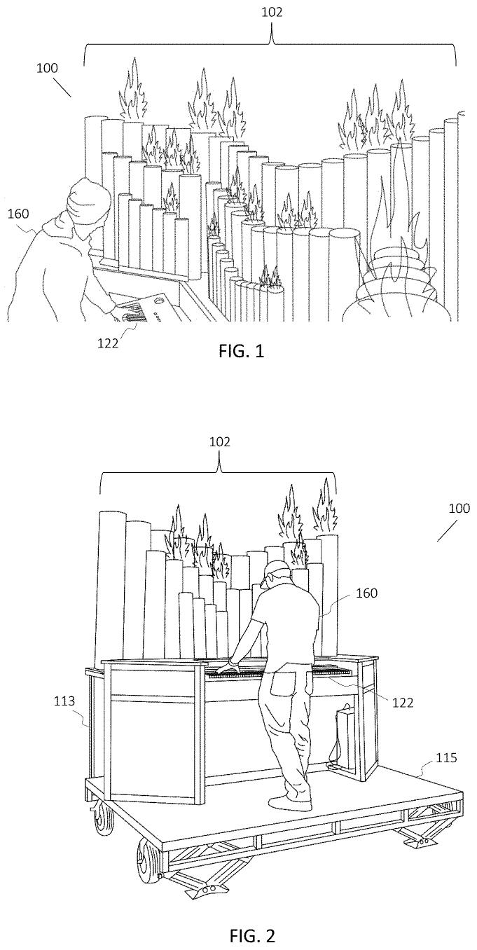

Turning to FIG. 1, a perspective view of an FTPO 100 is shown which includes a set of pipes 102 and a set of keys on a keyboard 122 that are functionally attached to the set of pipes. When a key is pushed, at least one flame effect appears in a corresponding pipe. The key functions as a control for the flame effect. In an example, the flame effect will remain for a period of time while the key remains being pushed. The set of keys may be arranged on a keyboard 122 and have a configuration like a standard keyboard, piano, organ, or other instrument.

In an example, a row of pipes may be angled relative to another row of pipes. As shown in FIG. 1, the pipes 102 include a first arrangement of three sets of pipes are positioned in parallel rows in front of a user 160, while a second arrangement of three sets of pipes are on one side of the user 160 and a third arrangement of three sets of pipes are on the other side of the user 160. The second and third arrangements are angled relative to the first arrangement of three sets of pipes. The pipes shown follow slanted sides around the keyboard 122. In another example, the pipes are placed in a rounded manner around the keyboard 122 (not shown).

Turning to FIG. 2, another perspective view of an FTPO 100 is shown. The FTPO 100 includes a frame 113 in which the pipes 102 and keyboard 122 are attached. The frame 113 includes supportive structure that holds the pipes 102 and keyboard 122. The frame 113 and keyboard 122 are supported on a stand 115. The stand 115 shown includes a rising mechanism for raising and lowering the keyboard 122 and pipes 102. In an example, the frame 113 includes mechanisms for raising and lowering individual pipes or sets of pipes relative to the stand 115. This allows selected visibility and variable aesthetic and visual effect on the shape of the pipes 102 and the FPTO 100 as a whole. The stand 115 shown further includes wheels and other structural elements for positioning and transporting the pipe organ.

The pipe arrangement includes three sets of pipes arranged in parallel manner. The pipes 102 are positioned in a stacked ascending arrangement in which the back pipes are at the tallest height, the middle row pipes are of a middle height, and the front pipes are at the shortest height. In this manner, the flames are visible from the front side of the organ. Additionally, the pipes 102 are in a descending taper from outer sides toward the central regions of the organ. In another example, the pipes 102 are staggered from side to side or back to front as well. The overall arrangement is such that the appearance of the flames mimics the arrangement of pipes of an organ.

The pipes 102 may be of the same size and same diameter or be different sizes and diameters. The pipes 102 may be in rows of the same length or of varying length relative to each other. The pipes 102 may include at least one set of pipes in a row. In another example, the pipes 102 may include two or more sets of pipes with each set of pipes in a straight row or other configuration.

The pipes 102 may include organ pipes or other channel-like structures that are made to look like real pipes of organs. In an example, the pipes 102 include aluminum, plastic, ceramics, or a combination thereof. The material may include material with fire-proof characteristics. The material may also include properties that allow designs to be molded or attached or otherwise included with the pipes 102. For example, a pipe made out of bones or bone looking structures may be used to provide a visual effect and flame enhancement.

The pipes 102 may include insulative, heat resistant, or fire-proof features. In an example, the pipes 102 are air duct pipes of various diameters that are cut and arranged to imitate pipes of a real pipe organ. The air duct pipes enclose copper pipes and solenoid valves that channel the propane gas. The pipes 102 may further include vents or holes. The pipes 102 may further include additional spacing and heights and positions, etc. that allow them to more fully imitate the pipes of an actual pipe organ.

Micro Flame Effects Unit (MFEU)

A micro flame effects unit (MFEU) is a unit that is placed within an FTPO pipe 102 and includes components to create the flame effects in the FTPO pipes 102. Two examples of MFEUs that are used to create the flames in the FTPO pipes 102 will now be described.

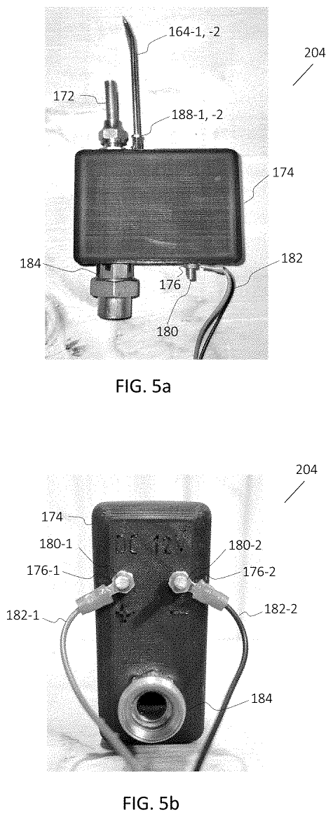

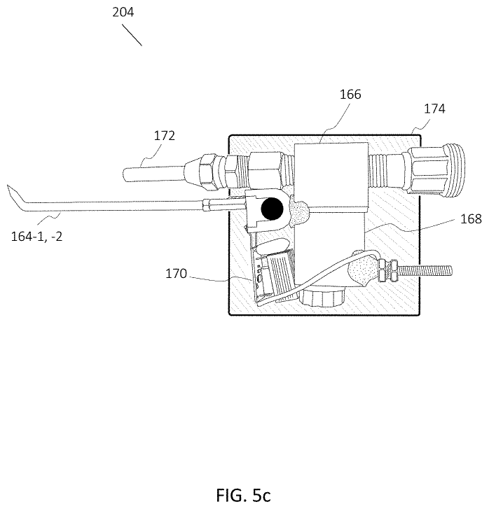

In the first example, the components include a pair of electrodes 164-1, -2, solenoid valve 166, ignition coil 170, and a gas pipe 172. In the second example, the components further include a block 174 (see FIG. 5a) to house and protect at least some of the components described in the first example.

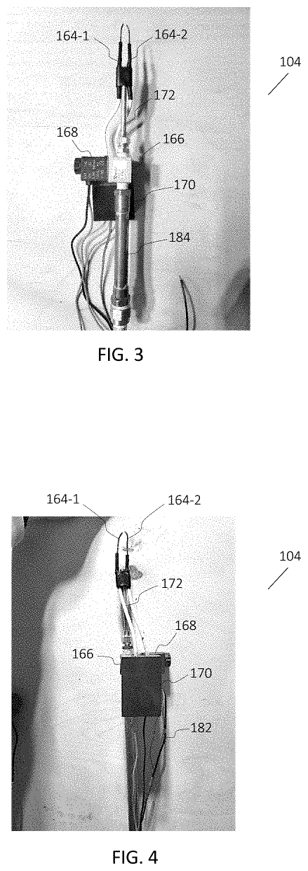

FIGS. 3 and 4 illustrate the first example. FIG. 3 illustrates the front side of an MFEU 100. FIG. 4 illustrates the back side of the MFEU 100. At the top of the MFEU 100 are a pair of electrodes 164-1, -2. The ignition coil 170 creates a high enough voltage between the pair of electrodes 164-1, -2 to create a hot plasma arc. The solenoid valve 166 releases gas in a controlled manner, the release of which is simultaneous with the electric arc created by the ignition coil 170. The electric arc ignites the gas to produce a flame effect.

The electrodes 164-1, -2 include a pair of rods or solid core wire with end portions that are curved or angled toward each other. The ends are further sharpened to a point. The curved, pointed ends leave a gap in which an arc may be formed. Between the curved end portions and at or near the base of the pair of rods is a solenoid valve 166 that releases gas through a gas pipe 172 into the air. Other types of valves are anticipated, included electric ball valves, servo motor valves, etc.

The distance between the curved end portions and the end of the gas pipe 172 provides a space for which the gas is to mix with air. The electrodes 164-1, -2 are spaced apart so that the electric arc is limited to being established between the ends where the slight bends in the electrodes 164-1, -2 bring the two ends closer together. The sharp pointed ends to enable the electric arc “make a jump” from electrode to electrode.

Sparks, as used herein, occur relatively briefly, such as a few milliseconds, while electric arcs can be held for relatively extended periods of time, such as several seconds to several minutes. Either one may be used as an ignition source. The electrodes 164-1, -2 extend outward from the other components by a distance to hold the electric arc above the other components and to allow space for the gas to mix with the air when it leaves the gas pipe 172.

For making the arc, the electrodes 164-,1 -2 include rods that are functionally attached to the ignition coil 170. In the example shown in FIG. 3, ends of the electrodes 164-1, -2 are connected to connective wires which are connected to the ignition coil 170 for electric ignition of the gas. The attachment may be accomplished, for example, by soldering. In an example, end portions and connective wires are partially covered by insulation, such as heat shrink, or other insulation to be electrically insulated from adjacent components. Particularly, the heat shrink may be located at solder points or other areas that are electrically conductive.

In an example, the ignition coil 170 takes 12V and converts it into 15 kV-20 kV, which is enough to create a hot plasma arc between the electrodes 164-1, -2 to ignite the propane gas. The ignition coil 170 produces an arc that pulses at such a high frequency that the human ear cannot hear the high pitch tone that the arc creates. Because the ignition coil 170 is attached to the solenoid valve 166, the ignition coil 170 is cast in a black epoxy or other material that is flame retardant, electrically insulating, thermally conductive and waterproof.

For gas release, the solenoid valve 166 or other controlled release mechanism, is used. The solenoid valve 166 is “normally closed” which means it will only open to release gas when it receives power (e.g. 12V, etc.). There are various sizes of solenoid valves. The solenoid valve 166 in this example have a ¼″ inlet and outlet which allows for enough gas flow to create a 3 ft-4 ft flame effect. Solenoid valves with smaller or larger inlets and outlets (i.e. ⅛″ or ½″ etc.) may be used to create larger or smaller flame effects. In an example, the gas released into air is propane gas communicated through the gas pipe 172 that extends parallel to a central axis of the electrodes 164-1, -2.

The ignition coil 170 may be cast in an electrically insulative material, such as a black epoxy. Other properties of the insulative material may include being flame retardant, thermally conductive, and waterproof. This is to protect against arcing to other objects and components, and to protect the ignition coil 170 from damage that may be caused by, high heat, impact, electrical shorts, water, and the flame effects.

In the second example shown in FIGS. 5a and 5b, the MFEU 204 includes a block 174 of flame retardant, thermally conductive, and electrically insulating epoxy is used to fully or partially encase the electrodes 164-1, -2, solenoid valve 166, solenoid coil 168, ignition coil 170, and gas pipe 172. FIG. 5c shows a cutout view of the MFEU 204.

The ignition coil 170 and the solenoid valve 166, including the solenoid coil 168 for the solenoid valve 166, are fully encased in a thermally conductive epoxy. Other properties of the epoxy include being flame retardant, electrically insulating, and waterproof. In an example, the epoxy is a potting compound epoxy that may be used to protect electronics. This full or partial encapsulation of the components is to further protect all components of the MFEU 204, from damage that may be caused by, high heat, impact, electrical shorts, water and the flame effects.

The epoxy or other material used includes properties of being 1) a solid color to completely conceal the internal components, 2) thermally conductive to act as a heat sink and thereby draw heat away from the components and thus extend operating time and overall working lifespan, and 3) electrically insulative to ensure that even with high voltage outputs, there are no internal shorts caused by the arcing, and 4) flame retardant.

FIG. 5a shows a side view of the block 174. On top of the block are located electrodes 164-1, -2 and the gas pipe 172. The electrodes 164-1, -2 are directly connected via threaded connections protruding from the block 174 to the output end of the ignition coil 170 that is located within the block 174. The electrodes 164-1, -2 are threaded on one end to make threaded connections to the block 174. Locking nuts 188-1, -2 secure the threaded ends of respective electrodes 164-1, -2 to the block 174.

Adjacent to the electrodes 164-1, -2 is a gas pipe 172 to release gas into the air for ignition of the arc. The ends of the electrodes 164-1, -2 are not directly on top of the gas pipe and straight flow of gas, but are adjacent to the gas pipe. This places the electrodes 164-1, -2 in a position to bring the electric arc in contact with the edge of the gas flow where the propane gas that has mixed with air.

On the bottom of the block 174 is an inlet for gas and electrical connections. The inlet communicates gas to the gas pipe 172 on the opposite side of the block 174. The inlet may be a pipe as shown or other connection that supplies gas to the gas pipe 172. The electrical connections supply power to the electrodes 164-1, -2 and solenoid valve 166 and will be described in greater detail below.

In the first example, the solenoid valve 166 and the ignition coil 170 receive power from different sources. In the second example as shown in FIG. 5a, the solenoid valve 166 and ignition coil 170 are electrically connected and receive power from the same electrical connection points protruding out of the inlet side of the block 174. The power source may be the same or different in either example, however. The solenoid valve 166 includes a solenoid coil 168.

The electrical connections are made with the brass rods 180-1, -2 that extend outward from the block. The brass rods 180-1, -2 can be seen in FIG. 5b. The brass rods 180-1, -2 connect to the ignition coil 170, and solenoid valve 166 that are located within the block 174. In an example, the brass rods 180-1, -2 extend outward from the block 174 by 5-15 mm or greater. As shown, the brass rods 180-1, -2 extend outward by 10 mm. The distance is such that a connection, either permanent or removable, may be made with an electrical outlet. Ring terminals or other attachment structure are to slide over respective threaded brass rods and be secured by the nuts 176-1, -2. Connective wires 182-1, -2 are crimped or otherwise attached to the ring terminals. In an example, the connective wires 182-1, -2 are partially silicone. They may also be flame-resistant. The connective wires 182-1, -2 may be attached with the ring terminals as described to allow the connective wires 182-1, -2 to be disconnected in case the MFEU 204 has to be removed or replaced, or if the connective wires 182-1, -2 get damaged or burned.

In an example, the block 174 further includes a diode. The diode is soldered to a positive and negative side of the circuit. When the MFEU 204 is being supplied with power, the diode does nothing. When power to the MFEU 204 is cut off, however, there is a reverse voltage and current spike created by the solenoid valve as it closes. Diodes only conduct electricity in one direction, much like a one-way valve in a water line. The diode is placed in the circuit of the MFEU 204 in such a way as to prevent this reverse voltage and current from back traveling to the FTPO driver boards and computers. The diode achieves this by providing an alternative path for the reverse voltage and current. The alternative path is back through the solenoid valve 166. The reverse current and voltage will loop back through the solenoid valve 166 until all electrical energy has dissipated. Complete dissipation may occur in a matter of milliseconds. Other forms of dissipation are anticipated.

For either the first or second examples, variations may be had. For example, the electrodes 164-1, -2 may be brass or copper. The diameter of the electrodes 164-1, -2 may be 3 mm, or approximately 3 mm. Other diameters are also anticipated. For example, 2 mm, 4 mm, and 5 mm diameters and anything in between is anticipated. Larger diameters may be used as well to accommodate different sized flame effects.

The connection points between the electrodes 164-1, -2 and the ignition coil 170 may be, for example, female-to-female M #s pacer stand off screws that have been soldered directly to the high voltage output end of the ignition coil.

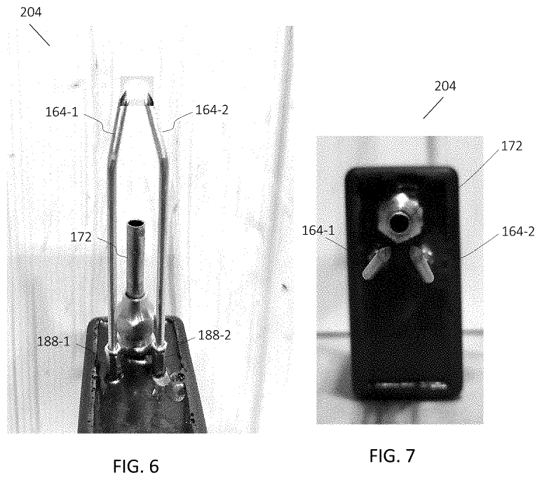

As shown in FIG. 6, end portions of the electrodes 164-1, -2 are angled to achieve an appropriate distance between the ends of the electrodes 164-1, -2. As stated previously, the ends of the electrodes 164-1, -2 are ground down to a sharp point to make pointed ends between which the arc is formed. This helps the electrical arc to be established in a relatively easy, fast, and reliable manner. The top view in FIG. 7 illustrates the angled end portions pointing toward the central axis of the gas pipe.

In an example, the distance between the ends of the electrodes 164-1, -2 is approximately 4 mm-6 mm. Other distances are anticipated. In an example, a distance is selected for the electrodes 164-1, -2 to be close enough to allow for a consistent and high heat arc, but also wide enough to allow enough surface area of the electric arc for reliable ignition by the ignition coil.

In an example, the bend in each electrode 164-1, -2 is 15-30 degrees starting at 20-25 mm from the respective sharp end of the electrode. Other angles are anticipated. The angled electrodes 164-1, -2 brings two ends closer together to ensure that the electrical arc will be achieved and then remain at the endpoints, as electricity follows the path of least resistance.

Variations in degrees and distances for the electrodes 164-1, -2 (e.g., 15-30 degrees, 20-25 mm, etc.) may occur due to slight imperfections in the exact placement of the electrodes 164-1, -2 relative to each other and the gas pipe. In an example, the electrodes 164-1, -2 are adjusted and fine-tuned to ensure reliable ignition of the gas every time.

In an example, the total length of the electrodes 164-1, -2 is approximately 100 mm and the linear length from the locking nut to the sharp tip is approximately 90 mm. Other lengths are anticipated, and include up to 20 mm more or less than the lengths provided. The electrodes 164-1, -2 are longer than the gas pipe 172 at least the following two reasons— 1) to provide enough space and time for the propane gas to mix with the oxygen in the air for combustion, and 2) to dissipate the high amount of heat created from the electric arc and flames that could otherwise potentially melt the electrodes 164-1, -2 or cause damage.

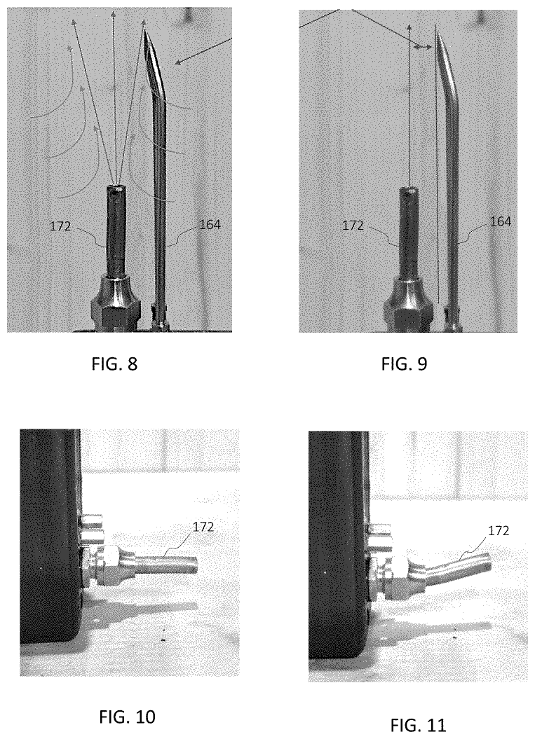

In FIG. 8, the flow of gas is shown by arrows. The gas is directed upward. Ambient air is directed inward and upward to mix with the gas. The space between the two ends of the electrodes 164-1, -2 and the end of the gas pipe 172 allows the gas and air to combine. In FIG. 9, the offset between the electrodes 164-1, -2 and electrical arc from the center of the gas pipe 172 is indicated by an arrow. In an example, the offset is 5-10 mm. The purpose of the offset is for at least the following two reasons— 1) if the arc is directly over the gas pipe 172, the high flow of gas blows directly on the arc, making the arc not strong enough (i.e., hot enough) to ignite the gas, and 2) there is a more consistent ignition when the arc is placed on the edge of the gas flow, where the gas mixes with the oxygen in the air. Gas, such as propane gas, alone cannot burn. It can, however, be burned when it is mixed with an appropriate ratio of air.

In an example, the gas pressure from the propane tanks are between 100-200 psi. The gas communicated between the gas regulator and the gas solenoid valve (after the gas passes through the regulator) is 10 psi. The gas regulator reduces the high pressure to a lower pressure, and the 10 psi gas is what the solenoid valve 166 release for the flame effect. Note that the gas pressure may vary depending on surrounding temperatures. Other gas pressures and reductions in pressure are anticipated.

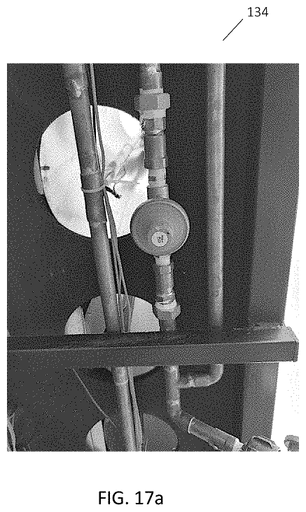

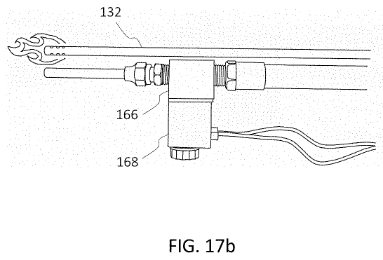

In an example shown in FIG. 17a, at least one gas regulator 134 is used in the FTPO 100. In an example, six (6) regulators are used, each regulator incorporated for a designated section of the organ pipes. Because the gas regulators have a limited flow capacity, a plurality of gas regulators may be desired to meet relatively high flow capacities required by the FTPO 100. The more gas regulators being used, the higher the overall gas flow capacity the gas lines have to supply the flame effects. The gas regulators may also have pipe connections that allow them to be easily removed from the main gas line and replaced if needed.

When the electrodes 164-1, -2 are made, and secured in place for the MFEU 204, difficulties may arise in fine tuning them. An example fine-tuning option for ignition reliability is bending the gas pipe to shift the direction of the gas flow. FIG. 10 shows an example copper tube and FIG. 11 shows an exaggerated example of a bend in the copper tube to make adjustment. Actual adjustments are generally not as noticeable to perform fine-tuning of the gas pipe 172. In other examples, other measures may be taken to perform fine-tuning.

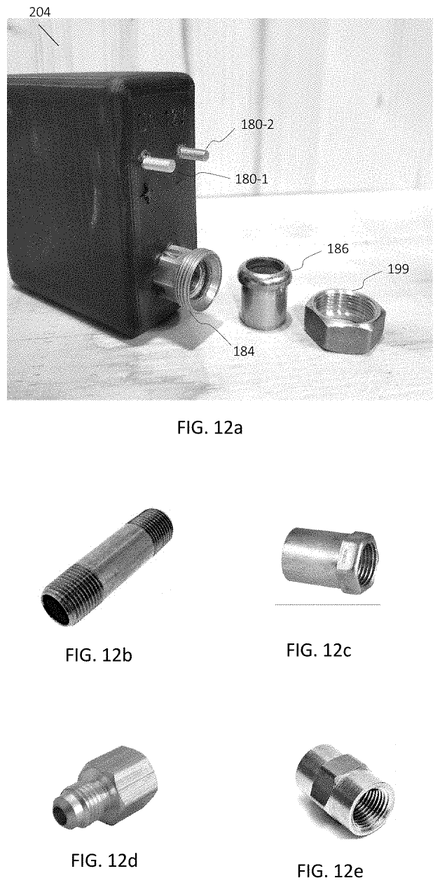

FIG. 12a illustrates the separate pieces that make the union of the MFEU 204 to a main gas line which supplies the gas for the MFEU 204. As shown, an example intake pipe, a ½″ copper solder cup with a male bevel 186, and a nut 199 are used. This specific union may be chosen for at least the following two reasons— 1) to make the MFEU 204 relatively easy to remove from the main gas line or replace it entirely, and 2) before tightening the union completely, the hangover of the MFEU 100 may swivel around to whichever side of the main gas line which makes it relatively easier to place in tight areas (i.e., organ pipes). The ½″ solder cup with the male bevel 186 may be soldered to a pipe that supplies the MFEU 204 with gas. The ½″ solder cup with the female bevel 184 may be soldered to threaded adapters to thread the female half of the union to the solenoid valve 166. A portion of the ½″ solder cup with the female bevel 184 and its threaded adapter may be encased in the epoxy block 174 of the MFEU 204. The nut 199 clamps the two halves of the union together.

Additional securement may be achieved with yellow PTFE tape on both halves of the union of the copper and gas pipe, to ensure an airtight connection.

Connections to establish a union between the MFEU 204 and a gas pipe or other gas source may vary. FIGS. 12b, 12c, 12d, and 12e illustrate various other connections. Although sizes are given, they are provided for illustrative purposes only and may vary.

FIG. 12b illustrates a ¼″ MPT to MPT nipple. One end of the MPT nipple is to thread into the solenoid valve and be concealed in the block while the other end will protrude out of the block to be connected to a propane source. The three following connections may require this first connection or a similar threaded connection.

FIG. 12c illustrates a ¼″ FPT to ½″ C adapter. The adapter is to be soldered directly to a ½″ copper pipe.

FIG. 12d illustrates ¼″ FPT to a flare connection. Flare connections have several sizes (e.g., ¼″, ⅜″, ½″, etc.) to be used for the gas connection. The flare end connects to a propane hose with a female flare end. In another example, the flare end connects to flexible copper pipe that has been flared, and threads on with a flare nut.

FIG. 12e illustrates ¼″ FPT to ¼″ FPT coupling. The coupling is to be used to connect a propane hose that has a ¼″ MPT end.

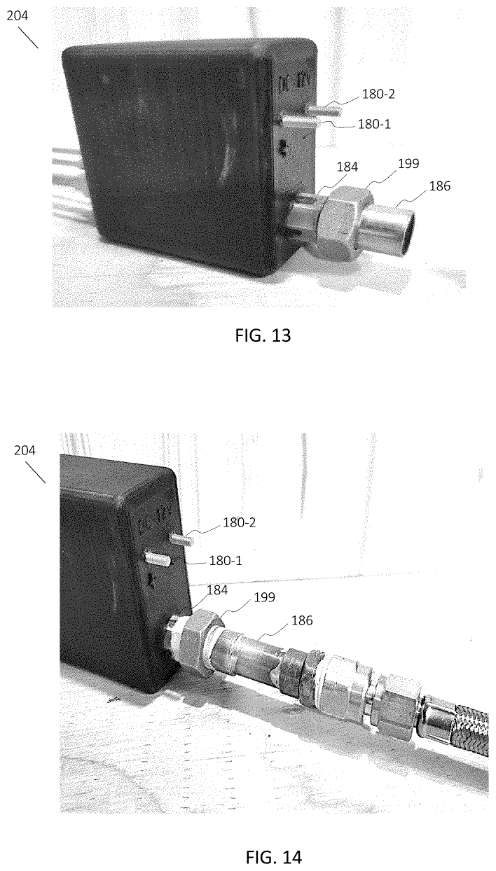

A ½″ copper pipe may be attached to the ½″ solder cup with the female bevel 186, nut 199, and intake pipe 184, as shown in FIG. 13.

An appropriate gas connection to the ½″ copper pipe may be made as shown in FIG. 14 with intake pipe 184, nut 199, and copper solder cup with the male bevel 184.

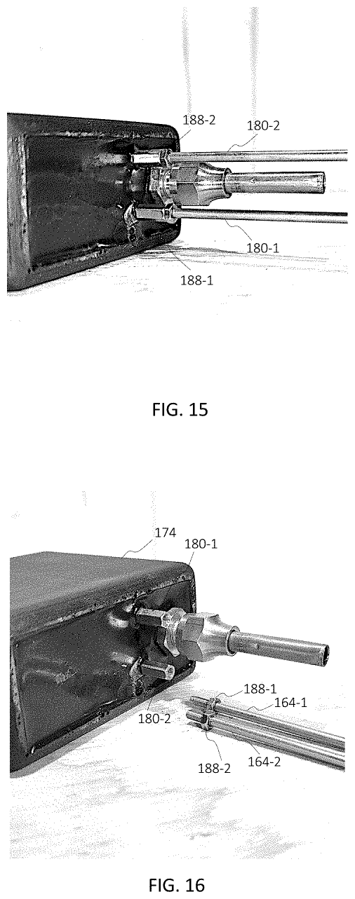

Turning to FIG. 15, an example attachment of the electrodes 164-1, -2 to the ignition coil 170 are shown. The attachment is accomplished with female to female M3 spacer stand off screws that are soldered directly to the high voltage output end of the ignition coil 170.

FIG. 16 shows unattached electrodes 164-1, -2. Nuts 188-1, -2 on the threaded end of the electrodes 164-1, -2 tighten and secure the electrodes 164-1, -2 when the electrodes 164-1, -2 are screwed on their threaded ends into the connections of the ignition coil 170.

In an example, the tops of the electrodes 164-1, -2 of the MFEU 204 are approximately 2″ below the top of the pipes 102 to hide them and also protect the base of the flame from the wind.

The MFEU 204 may further be used in additional environments besides an FTPO 100. In an example, a single MFEU 204 is used to create the fire that escapes the mouth of a statue or moving figure, such as a fire-breathing dragon figure. In another example, the MFEU 204 or a set of MFEUs 204 are used in conjunction with a light show that incorporates other light effects. For example, the MFEU 204 may be used as part of a firework show or a festive light display. The MFEU 204 may light up in sync with flashing lights or light up figurines or provide other visual effects in a display.

Instead of a flame effect, the MFEU 204 may be adapted to release fog instead. In an example, instead of ignition coils 170 and electrodes 164-1, -2, heater blocks include a relatively small tube or pipe running through the center of the heater block. A solenoid valve underneath the heater block releases fog juice, which travels through the heater block and vaporizes into a fog. A pressurized fog juice reservoir pushes the liquid fog juice through the entire system to and through the solenoid valves and heater blocks.

In addition to the flame effects, the FTPO 100 may also be adapted to control various lights. In an example, the FTPO 100 is used to control Christmas lights on a house. The lights controlled by the FTPO 100 may be synchronized with prerecorded songs of the FTPO 100, or they may be controlled by a musician playing the keyboard 122. The lights may or may not accompany the flame effects as the FTPO 100 is being played. The control of lights may be done in the same or similar manner as the MFEU 204 for the flame effects. Instead of turning on an MFEU 204 with the press of a key, the FTPO 100 may be used to turn on a set of lights with the press of a key. In an example, a set of lights may be turned on by one key, and another set of lights may be turned on by another key. In another example, the FTPO 100 turns on an MFEU 204 along with a set of lights with the press of a key, and the FTPO 100 turns on another set of lights and another MFEU 204 with the press of another key.

FIG. 17a shows an example gas regulator that may be used to reduce the relatively high pressure (i.e. 100-200 psi) of a propane tank to a lower and usable pressure (i.e. 10 psi). In the example shown, the gas regulator has ¼″ FPT connections for an inlet on one side and an outlet on another side. The main gas line in this example uses ½″ copper pipe. To connect the gas regulator to the main gas line, a ¼″ NPT nipple is used to connect the gas regulator to a ¼″ FPT to ½″ C adapter. The ½″ solder cup of the adapter is soldered to a short section of ½″ copper pipe. On the opposite end of the short section of ½″ copper pipe there is a ½″ union. This is the same ½″ union used to connect the MFEU's to the main gas line. One half of this union is soldered to the short section of ½″ copper pipe, and the other half of the union is soldered to the main gas line. A brass nut slides over one half of the union, and threads onto the other half of the union. When this nut is tightened it clamps to the halves of the union together to make an airtight connection when wrapped in PTFE tape.

This series of connections is repeated on both the inlet and outlets of the gas regulator. Installing the gas regulator with the ½″ unions allows a gas regulator to be removed and replaced if a gas regulator stops functioning correctly. To remove a gas regulator, the two brass nuts that clamp the two ½″ unions together can be simply unscrewed and the regulator removed from the main gas line. Other connections are anticipated.

FIG. 17b illustrates ignition made possible with a pilot light 132 instead of an ignition coil with electrodes 164-1, -2. A pilot light 132 is a small flame that is constantly burning next to the outlet pipe of solenoid valve 166. To achieve the pilot light ignition, a series of relatively small gas pipes run parallel to a main gas line. The gas pipe end releases gas adjacent to the end of the outlet pipe of the main gas line where the solenoid valves release relatively high-pressured gas (e.g., 10 psi propane gas). The small gas pipes provide a constant low flow of gas that can be lit at open ends of the small gas pipes. The open ends provide small flames that are constantly burning, and that will ignite high-pressured gas that is released by the solenoid valve 166, to create flame effects.

FIG. 17b shows the ignition method using a pilot light. The solenoid coil 168 of the solenoid valve 166 is on the left-hand side, with power wires hanging beneath it. The solenoid valve 166 housing of the solenoid is on the right-hand side with gas pipes connected to it on the top and bottom. In this example, the solenoid valve 166 uses ¼″ FPT connections for the pipes. The gas pipe below the solenoid valve 166 is part of the main gas line running throughout the FTPO. This gas pipe supplies the pressurized gas (i.e. propane gas at 10 psi). In an example, the gas pipe is ½″ copper pipe that has a ½″ C to ¼″ FPT adapter, that is soldered to the end of the pipe. A ¼″ nipple is used to connect the solenoid valve 166 to the gas pipe's thread adapter. On top of the solenoid valve 166 is a ¼″ MTP to ¼″ flare union. This union threads directly into the solenoid valve 166. A short piece of flexible ¼″ copper pipe is flared and then secured onto the flare union using a flare nut. The gas that is communicated through the solenoid valve 166 passes up through this short segment of ¼″ copper pipe, to be released into the air for the ignition. The short segment of ¼″ copper pipe provides a distance by which the base of the flame effect is held away from the solenoid valve 166, to help protect against heat damage to the solenoid valve 166. In another example, the solenoid valve 166 may be cast in a block of flame retardant epoxy to further protect it from the flames. Additional characteristics of the flame retardant epoxy may include being a solid color to conceal internal components, thermally conductive, and electrically insulting.

In the example shown, the solenoid valve 166 is not encased in such epoxy. Other methods of protecting the solenoid valve 166 from flame effects are anticipated. To the right of the solenoid valve 166, there is another ¼″ copper pipe 132 that is not connected to the solenoid valve, or the main gas line. This pipe has a separate gas supply, provides a constant low flow of gas (i.e. propane) to be released into the air. The gas released from this pipe is lit to create a relatively small pilot light that is constantly burning next to the outlet pipe of the solenoid valve 166. The pilot light may be only an inch in length, or it may be several inches in length (i.e., 12 inches or more). This pilot light 132 serves as the source of ignition for the pressurized gas that is released by the solenoid valve, to create a flame effect. At the end of the pilot light 132 are several holes drilled into it. These holes give the base of the flame more channels of gas which helps prevent the pilot light from being “blown out” by the high-pressure gas from the solenoid valve, when the valve opens.

The solenoid valve in this example works the same as in the MFEU's with electric ignition. The solenoid valve may also utilize a diode, as described for the MFEU's with electric ignition, however, the diode is in either the driver boards or the solenoid valves wires. The solenoid valve 166 is closed and will only open to release the gas when it has been supplied with power (i.e. 12V) When a user presses the corresponding key, the solenoid valve 166 is supplied with power and will open up to release the pressurized gas. The gas is ignited by the pilot light 132 and the flame effect is created. The solenoid valve 166 will remain open and sustain the flame effect for as long as the user is pressing the key. When the user releases said key, the solenoid valve 166 will close, and the reverse voltage and current from solenoid valve 166 closing is dissipated by the diode, and the flame effect is extinguished, leaving just the small pilot light 132 burning. The solenoid valve 166 and the pilot light 132 can create and extinguish flame effects as fast as the user can press the key, with no perceivable delay.

In an example, the pilot light ignition is the ignition method used in a FTPO. In another example, the pilot light ignition may be used in conjunction with the electric ignition method of the MEFU's. (i.e. some organ pipes use pilot lights, and other organ pipes use the MFEU's with electric ignition.)

In another example, a fuse may be located in between the MFEU power supplies and the driver boards. All electricity going to the MFEUs 104-1, -2, -3, -4, -5, -6, -7 pass through the fuse and the fuse protects the power supply and circuits. In the event that too many keys are pressed at once, a large amount of power would be drawn and could potentially damage the power supply and circuits without the fuse.

In an example, there may be fuses placed in the power supply wires of each MFEU, that will protect the individual MFEUs if they draw too much current. In another example, there may be a fuse in between the key solenoids and the power supply for the key solenoids, to protect the power supply in case too many key solenoids are turned on at once.

Manual Operation

The description will now describe the manual operation of an FTPO 100 with reference to an MFEU 104, noting that an MFEU 204 also applies, along with other variations described herein. When the MFEU 204 has been connected to a gas line and connected to a power source, it is ready to create a flame effect. For use in an FTPO 100, the controlling device for the flame effect in each organ pipe is the keyboard 122, or other key arrangement.

For a manual FTPO 100, a standard keyboard 122 that produces a pipe organ sound may be used. Variations further include keyboard 122 that omits a pipe organ sound. In the example shown in FIG. 17, the keyboard 122 sends out a musical instrument digital interface (MIDI) signal as it is being played. The MIDI signal includes information that allows it to control whether a note is played or not. The MIDI signal further controls a property of the note being played, such as volume, duration, etc. Each key on the keyboard 122 has a unique MIDI ID assigned to it. The MIDI signals provide the manner in which the keyboard 122 is able to control the different components of the FTPO. Particularly, each MFEU 104 is assigned to one or more keys on the keyboard 122. When a key is pressed, the assigned MFEU 104 to that key produces a flame effect.

In an example, a USB MIDI host 118 adapts a USB MIDI connection to a 5 pin MIDI connection or vice versa. This allows different MIDI connections to be used since the USB MIDI host 118 has a single pair of input and output connections or multiple input and output connections.

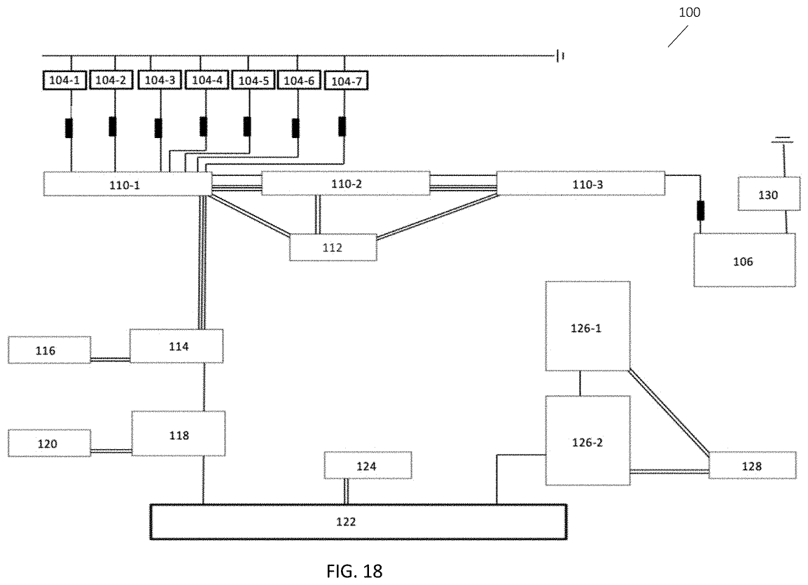

A control device, such as a microcontroller 114 or other device, receives MIDI signals from the keyboard 122 or USB MIDI host 118. In response, the microcontroller 114 sends out specific control signals that cause the corresponding MFEU 104 to make the flame effects. The microcontroller 114 may be an Arduino, a Raspberry Pi, a PLC, a custom-built microcontroller 114, or any other micro-controller on the market that serves purposes herein. There may be a single MIDI connection on the microcontroller 114, or there may be many MIDI connections. In the example shown in FIG. 18, there is just one MIDI connection.

In an example, at least one key on the keyboard 122 is assigned to at least one MFEU 104. The keys may be attached so that one key is attached to one pipe. In another example, at least two or more keys are attached to one pipe. In another example, one key is attached to more than one pipe. In another example, multiple keys are attached to multiple pipes. In another example, a key is attached to one pipe, and the same key used in conjunction with another key is attached to a different pipe. Various arrangements of keys and pipes are anticipated.

The MFEU 104 do not produce a flame effect or “fire” until they have received power. Driver boards channel power from the power supply to each individual MFEU 104. In this example, the driver boards channel power to the MEFUs 104-1, -2, -3, -4, -5, -6, -7 from a single power supply 106. Each driver board will be programmed to react to a set of specific control signals from the microcontroller 114.

In the example shown, the three individual driver boards are labeled 110-1, 110-2, 110-3. The control signals coming from the microcontroller 114 are indicated by dotted lines. Each MFEU 104 is connected to a single power channel on the driver boards. Power channels are indicated by solid lines.

Each driver board 110-1, 110-2, 110-3 is connected to a set of respective MFEUs 104-1, -2, -3, -4, -5, -6, -7. For purposes of the example, only driver board 110-1 is described and the corresponding MFEUs 104-1, -2, -3, -4, -5, -6, -7 are not shown for driver boards 110-2, 110-3. Other setups and configurations are anticipated, with more or less driver boards fully anticipated.

As shown, driver board 110-1 is connected to MFEU 104-1, -2, -3, -4, -5, -6, -7. Driver board 110-1 is supplied power by power supply 112. Power supply 112 is the power source for driver boards 110-2, 110-3 as well. The MFEUs 104-1, -2, -3, -4, -5, -6, -7 receive power from power supply 106. A switch 130 is connected to the power supply 106 for emergency shut-off of the entire system. In an example, the switch disconnects the MFEU 104 power supply 106 from the same ground that the MFEUs 104-1, -2, -3, -4, -5, -6, -7 are grounded to. With the switch off, the circuit of the MFEUs 104-1, -2, -3, -4, -5, -6, -7 cannot be completed, and the MFEUs 104-1, -2, -3, -4, -5, -6, -7 cannot turn on even when keys are being pressed. The switch 130 allows for safety, in that the FTPO may be disabled temporarily and quickly if a hazard arises, or if the operator is not immediately next to the FTPO. The switch 130 will not turn off any other components of the FTPO, so it is possible to play music without the flame effects if desired. When the disabling switch 130 is turned back on, the FTPO is immediately ready to produce flame effects again.

A microcontroller 114 controls the driver boards 110-1, 110-2, 110-3 to actuate the MFEUs 104-1, -2, -3, -4, -5, -6, -7 according to signals received by a MIDI host 120. The power supply 116 for the microcontroller 114 is shown. The power supply 120 for the MIDI host 118 is also shown.

The MIDI host 118 receives signals from the keyboard 122. The power supply for the keyboard 122 is shown.

Speakers 126-1, -2 for the keyboard 122 provide sound that is synced with the MFEU 104 flame effects by the microcontroller 114. The power supply 128 for the speaker is shown. The audio provided for the speakers stems from the keyboard 122 itself.

Note that power for multiple components may come from a single power supply. In an example, two or more components in the configuration share the same voltage requirement, and those components share the same power supply.

In an example, an organ pipe is assigned to a specific key on the keyboard 122. As an explanation, we will use the note “Middle C” which is the key in the very center of the keyboard 122. We will shorten “Middle C” to MC. When a user plays a key, the keyboard 122 sends out at least one signal to a component or computer within the FTPO 100. When a user 160 presses the MC key, the keyboard 122 sends audio to the speakers for the note MC while simultaneously sending out the “note on” MIDI signal for the MC key. For a keyboard 122 that uses a USB MIDI connection, the “Note On” MC MIDI signal is sent to the USB MIDI 118 host via a USB cable. The signal is sent by the MIDI host to a microcontroller 114 that is programmed to fire the assigned pipe of the pressed key. In this example, the USB MIDI host relays the “Note On” MC signal to the microcontroller 114 via a 5-pin MIDI cable.

When the microcontroller 114 receives the “Note On” MC MIDI signal, its programming causes it to send an “on” signal to the driver boards for the MC's assigned MFEU 104-1, -2, -3, -4, -5, -6, or -7. The driver board 110-1, -2, -3 channel power to a specific pipe, or pipes, based on the signals received from the microcontroller 114. When an MFEU 104-1, -2, -3, -4, -5, -6, or -7 receives power (e.g. 12V) from the driver boards, the solenoid valve opens, and gas starts to flow. At the same time, the ignition coil 170 converts the voltage (e.g. 12V, etc.) to a higher voltage (approximately 20 kV, etc.) which allows an arc to be created at the end of the electrodes 164-1, -2. The arc ignites the propane gas and produces a 3 ft-4 ft flame effect. As long as the key is pressed on the keyboard 122, the valve will remain open, and there will be an electric arc to continuously ignite the gas. The flames are not self-sustaining and require the arc in order to sustain the flame effect.

When the driver boards receive the “on” signal it closes the circuit for the MC MFEU 104-1, -2, -3, -4, -5, -6, or -7, thus supplying the MC MFEU 104-1, -2, -3, -4, -5, -6, or -7 with power, and creating a flame effect.

As soon as the musician releases the pressed key, the power is cut off to the MFEU 104-1, -2, -3, -4, -5, -6, or -7 and the arc instantly stops, the solenoid valve closes which instantly extinguishes the flame effect, the reverse voltage and current are dissipated by the diode, and the MFEU 104-1, -2, -3, -4, -5, -6, or -7 is immediately ready to fire another flame effect upon the press of a key. The MFEU 104-1, -2, -3, -4, -5, -6, or -7 may produce flame effects as fast as the user may press the keys, with no perceivable delay.

When the musician releases the MC key, the keyboard 122 stops producing the audio, and sends out a “Note Off” MIDI signal for MC.

The “Note off” MIDI signal follows the same path as described for the “Note On” MIDI signal. The only difference is that the microcontroller 114 sends an “off” signal for the MC MFEU 104-1, -2, -3, -4, -5, -6, or -7, and the driver board opens the circuit, thus cutting off power to the MC MFEU 104-1, -2, -3, -4, -5, -6, or -7 and extinguishing the Flame Effect.

Automatic Operation

An FPTO may be self-playing instead of having manual play. This allows the FPTO to play music with flame effects, but without a user being present. The automatic FPTO 200 will now be described. Note that the examples described include a system in which the automatic FPTO 200 is automated but still allows a musician to manually play music.

In an example, a computerized piano player system (“the player system”) is fitted to an acoustic piano so as to play live piano music at the touch of a button. The player system uses solenoids that are installed underneath the piano keys and pedals to precisely control movement, velocity, and duration of the piano keys. The player system may be relatively low profile to accommodate space and visual appearance of the automatic FTPO 200. The player system may also be modular, with different components easily accessed after installation. The player system may also be such that it does not require the physical hammers of acoustic pianos.

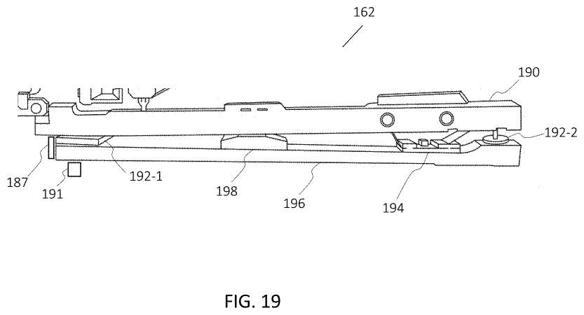

In FIG. 18, a piano key 162 taken from an acoustic piano is shown that may be used in an automatic FPTO 200. Key components of the key 162 that are used for the automatic key set of the automatic FPTO 200 include the keypad 190, plunger 187, solenoid and solenoid rail 191, fulcrum 198, keybed 196, end-stop 192-1, -2, and sensor strip 194. Other components may also be used and are anticipated. Parts may be ordered individually, salvaged from old pianos, or otherwise obtained. The set of moving parts, such as hammers and levers, is referred to as the action of the piano. The action and total length of the keys will be different on a grand piano vs an upright piano and each will work for the automatic FTPO 200. This allows a variable set of keys to be used for the automatic FTPO 200. If a grand piano or upright piano is used to make the automatic FTPO 200, unneeded parts, such as hammers, etc., may be removed to save space on the automatic FTPO 200 and simplify the build.For installation, the keys are prepared with the various components shown in FIG. 19 and installed on a keybed with the player system functionally attached. A keyboard and console housing may be built around the keyboard and player system. In an example, two or more sets of keys, keyboards, or other key arrangements are stacked on top of each other like a traditional organ.

Each set of FTPO 200 keys is attached to a common player system or a separate player system. In an example, each key set is a fully functional self-playing MIDI controller that is to control a respective set of FTPO 200 pipes. The overall effect is to provide visual effects that are synchronized with the keys as they are played.

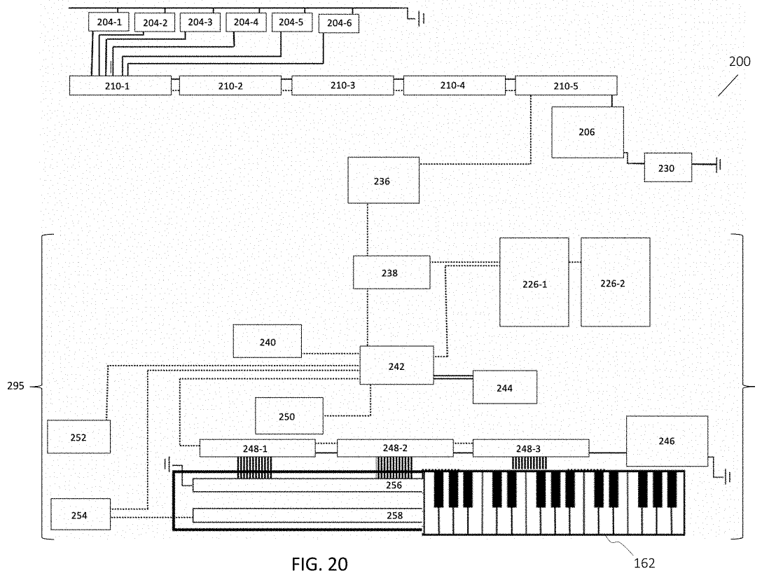

In FIG. 20, a diagram is shown for an automatic FTPO 200. Note that solid lines indicate power and dotted lines indicate signals (e.g., MIDI signals, audio signals, control signals, etc.). For purposes of discussion, a player system 295 as used herein includes a solenoid rail 256; sensor strip 258; record box 254; volume control box 252; driver boards 248-1,-2,-3; a bluetooth control module 250; main central processing unit (CPU) 242; CPU power supply 244; wireless MIDI control module 240; MIDI sound card 238; speakers 226-1,-2; and player system power supply 246. This list is not intended to be exhaustive of the components incorporated. Less components may be incorporated. Additional components not listed may also be incorporated.

In an example, the player system 295 uses musical instrument digital interface (MIDI) signals to turn a set of piano keys 162 into a MIDI controller. The main CPU 242 and solenoid rail 256 are located underneath the back end of the piano keys 162. The solenoids on the solenoid rail 256 apply a force on the piano keys 162 to play the piano. The record box 254 is connected to a sensor strip 258 (i.e., a strip of optical sensors) that sit underneath the front end of the piano keys 162. Piano keys 162 are played as controlled by the player system 295, and specifically the main CPU 242 controlling solenoids on the solenoid rail 256. In an example, the piano keys 162 may be played by the player system 295 as well as a user. When the piano keys 162 are played by the user, sensors on the sensor strip 258 output MIDI signals to the record box 242 and the main CPU 242 instead of the main CPU 242 controlling the piano keys 162 through the solenoids on the solenoid rail 256.

There are two sets of driver-boards, namely, driver boards 210-1, -2, -3, -4, -5 and driver boards 248-1, -2, -3. Driver boards 248-1, -2, -3 control the solenoid rail 256 of the player system 295 and driver boards 210-1, -2, -3, -4, -5 control flame effects of the MFEU's 204-1, -2, -3, -4, -5. Driver boards 248-1, 248-1, 248-3 channel power to each of the key solenoids on the solenoid rail 256 based on the control signals received from the main CPU 242. Each key solenoid in the solenoid rail 256 underneath the piano keys will only play one key when it receives power from the driver boards 248-1, -2, -3. The main CPU 242 sends control signals to the driver boards 248-1, 248-1, 248-3 to turn on and off the key solenoids that play the corresponding keys and notes of the selected song. In an example, when a key solenoid turns on, the key solenoid pushes a plunger upward which applies force on the back end of the key to pivot the front end of the key down, as if it is being pressed by a person.

Driver boards 210-1, -2, -3, -4, -5 are controlled by the microcontroller 236 in a very similar way as described for the manual FTPO 200 system. The main difference is that the MIDI signals that are received by the microcontroller 236 come from the main CPU 242. The main CPU 242 sends out MIDI signals to other components while the FTPO 200 is both automatically playing or being played by a user.

When the microcontroller 236 receives a MIDI signal from the main CPU 242, the microcontroller 236 will send a signal to the corresponding driver boards 210-1, -2, -3 to turn on or off the corresponding MFEU. Each MFEU 204-1, -2, -3, -4, -5 is connected to a single power channel on the driver boards 210-1, -2, -3. For purposes of the example, only driver board 210-1 is shown and described for its corresponding MFEUs 204-1, -2, -3, -4, -5. Other setups and configurations are anticipated, with more or less driver boards fully anticipated.

In summary, the main CPU 242 may use the key solenoids to play the FTPO 200, just as a musician would, and the rest of the system would behave as if there was a musician playing the FTPO 200, and there would be audible musical notes and flame effects. Each key on the keyboard sends out a MIDI signal as the key is being played. The MIDI signal is used to control the flame effects. The main CPU 242 and/or MIDI sound card 238 produces the audio.

The MFEUs 204-1, -2, -3, -4, -5 receive power from power supply 206. A switch 230 is connected to the power supply 206 for emergency shut-off of the entire system. In an example, the switch disconnects the MFEU power supply 206 from the same ground that the MFEUs 204-1, -2, -3, -4, -5 are grounded to. With the switch off, the circuit of the MFEUs cannot be completed, and the MFEUs 204-1, -2, -3, -4, -5 cannot turn on even when keys are being pressed. The switch 230 allows for safety, in that the FTPO 200 may be disabled temporarily and quickly if a hazard arises, or if the operator is not immediately next to the FTPO 200. The disabling switch 230 will not turn off any other components of the FTPO 200, so it is possible to play music without the flame effects if desired. When the disabling switch 230 is turned back on, the FTPO 200 is immediately ready to produce flame effects again. In an example, the MFEUs can produce flame effects as fast as the user can press the key with no perceivable delay.

The microcontroller 236 may be an Arduino, a Raspberry Pi, a PLC, a custom-built microcontroller 236, or any other microcontroller 236 that is known in the field.

The wireless MIDI control module 240 a module that connects to the Main CPU via signal wires, and allows the Main CPU to wirelessly connect to other MIDI devices, such as another MIDI based instrument, a MIDI synthesizer, or tablet or computer with MIDI programs on them.

The wireless Bluetooth control module 250 connects to the main CPU 242 via signal wires which allows for Bluetooth control of the main CPU 242. A tablet or computer may have pre-recorded songs saved on them that can be sent via Bluetooth to the main CPU 242 to play on the FTPO 200.

The volume control box 252 is a box by which the user can easily control the volume of the speakers.

In the automatic FTPO 200 in the shown diagram, no USB MIDI host is necessary, as the separate components can directly connect to each other. Examples may include a USB MIDI host, however.

In an example, the main CPU 242 plays at least one of locally recorded songs, songs received from Bluetooth control, songs that are received via the wireless MIDI module, and other types of songs. Note that as the main CPU 242 is playing the keys with the key solenoids, it also outputs audio to the speakers 226-2, -3 for the notes being played, because there is no acoustic element of the FTPO 200 to create the musical notes. Another option for audio is a MIDI sound card 238. The main CPU 242 has several different instrument voices the user can choose from. The MIDI sound card 238 provides the user with even further instrument voice options. The MIDI sound card 238 will output audio to the speakers 226-1, -2 for the notes represented by the MIDI signals that it receives from the main CPU 242. The MIDI sound card 238 may be incorporated into the manual FTPO 200 to give the user more instrument voice options, in addition to the instrument voice options provided by the keyboard.

The record box 254 of the player system 295 allows the user to locally record their own songs on the FTPO 200 as they play. The main CPU 242 may then replay the recordings. The main CPU 242 may also receive songs to play, via Bluetooth, WiFi, or a corded connection from a tablet, computer, or other MIDI compatible control devices.

In an example, the player system 295 plays pre-recorded songs. In an example, the player system 295 further includes the ability to record songs and play back recorded songs. In an example, the system is controlled wirelessly via Bluetooth. The user may create a MIDI sequence on a MIDI synthesizer and the player system 295 will play it.

While the power supplies for the key solenoids and MFEUs 204-1, -2, -3, -4, -5 are represented in this diagram, additional components will have a power supply although not represented in the diagram. A component may have its own power supply, or it may share a power supply with other components.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention. In some cases, the parts recited in the claims can be utilized in a different method or attached in a different order and still achieve desirable results. In addition, the parts depicted in the accompanying figures do not necessarily require the particular order or shape shown to achieve desirable results. In certain implementations, modifying the base member, attachment members, or fins may be advantageous.

What is claimed is:

1. A flame thrower pipe organ (FTPO), comprising:
a set of cylindrical members;
a flame effects unit (FEU) located within each cylindrical member;
a set of keys that provide a sound when a key of the set of keys is played;
a control device connected to the set of keys and to the FEUs,
the control device to cause an FEU to release a flame effect concurrent with the sound of a corresponding key being played.

2. The FTPO in claim 1, the FEU further comprising a solenoid valve to release gas for the flame effect.

3. The FTPO in claim 1, the FEU further comprising an ignition coil to provide a source of ignition.

4. The FTPO in claim 1, the FEU further comprising a pair of electrodes that include end portions that are bent or angled toward each other, with a distance between the ends.

5. The FTPO in claim 4, wherein ends of the end portions are sharpened to a point.

6. The FTPO in claim 1, the FEU further comprising a solenoid valve and an ignition coil that are encased in a block.

7. The FTPO in claim 6, the FEU further comprising a pair of electrodes that extend outward from the block.

8. The FTPO in claim 7, the FEU further comprising a gas pipe that extends outward from the block, the gas pipe being located adjacent to the pair of electrodes, the gas pipe to release gas to enable a flame effect.

9. The FTPO in claim 1, further comprising a speaker that plays sounds that are synced with the flame effects by the control device.

10. The FTPO in claim 1, wherein the FEU is a micro flame effects unit (MFEU).

11. An automatic flame thrower pipe organ (FTPO), comprising:
a set of cylindrical members;
a flame effects unit (FEU) located within each respective cylindrical member;
a control device connected to the FEUs to control a release of each flame effect;
a keyboard with keys that have solenoids underneath them;
a self-playing system that controls the solenoids to play the keys, each key making a sound when played,
the control device connected to the self-playing system such that the FEUs release a flame effect concurrent with a corresponding key being played by the self-playing system.

12. The automatic FTPO in claim 13, further comprising speakers connected to the self-playing system to output sounds for associated keys being played.

13. A micro flame effects unit (MFEU), comprising:
a block;
a solenoid valve within the block;
an ignition coil within the block;
a pair of electrodes attached to the block and that extend out outward from the block, end portions of the electrodes curved or angled toward each other; and
a gas pipe attached to the block, the gas pipe located adjacent to the pair of electrodes,
the ignition coil to receive a voltage to create a source of ignition between end portions of the electrodes, the solenoid valve to receive a voltage to release gas from the gas pipe, the spark and the gas to create a flame effect.

14. The MFEU in claim 13, wherein ends of the electrodes are sharpened.

15. The MFEU in claim 13, the MFEU further comprising a pilot light ignition instead of the ignition coil.

16. The MFEU in claim 13, further comprising a control device connected to the MFEU and a light, the control device to control the flame effect of the MFEU in conjunction with the light for a light effect.
